(19) United States
(12) Patent Application Publication
(10) Pub. No.: US 2011/0024937 A1
(43) Pub. Date: Feb. 3, 2011

(54) Tablet Formation System for Fully-Loaded Presses

(76) Inventors: Semen Dukler, Brooklyn, NY (US); Lev Tsygan, Brooklyn, NY (US); Michael Levin, West Orange, NJ (US)

Correspondence Address: LUCAS & MERCANTI, LLP, 475 PARK AVENUE SOUTH, 15TH FLOOR, NEW YORK, NY, 10016, US

(21) Appl. No.: 12/512,718

(22) Filed: Jul. 30, 2009

(51) Int. Cl. B29C 43/34; B29C 43/58

(52) U.S. Cl. 264/109; 425/125

(57) ABSTRACT

Rotary press machine including dies, pairs of upper and lower punches with a part of each lower punch being movable in a respective die to selectively enable formation of a cavity in the die, a feeding system for feeding powder material into the cavities, when present, in a feeding stage, a pressing system for pressing the upper and lower punches together in a pressing stage and a tablet ejection system for ejecting formed tablets from the dies in a tablet ejection stage. The upper and lower punches are rotated sequentially through the feeding stage, the pressing stage, and the tablet ejection stage to thereby enable formation of tablets if powder material is feed into the cavities in the dies. To enable selective formation of tablets and thereby optimize production thereof, an adjustment mechanism is provided and enables selective formation of the cavities in the dies. The adjustment mechanism may comprise removeable rings attached to at least one, or to a plurality of lower punches, which rings are selectively engaged by the adjustment mechanism.

### FIELD OF THE INVENTION

The present invention relates to rotary tablet formation press machines, which enable tablet formation and to systems and methods for the production of tablets being produced on a rotary press machine fully loaded with tooling. The present invention also relates to a technique for retrofitting an existing rotary press machine to control tablet formation.

### BACKGROUND OF THE INVENTION

Prior patents and published applications referred to herein are hereby incorporated by reference. Rotary press or tableting machines typically include one or more dies, a feeder mechanism for feeding powder material into each die, and upper and lower punches which are brought together to press the powder material in each die to form a tablet. In advance of a feeding position at which the feeding mechanism feeds powder material into each die, the lower punch is lowered by a lowering cam from a tablet ejection position (where the lower punch is leveled or slightly projects above the die top and a previously formed tablet, when present, is ejected from the die) to an overfill position. Lowering of the lower punch via the lowering cam to such an overfill position creates a cavity inside the die into which the powder material is drawn down both by suction and gravity to subsequently fill the cavity with powder material at the feeding position, which powder material is compacted after the die passes the feeding mechanism, i.e., by passing the upper and lower punches through a pressing stage.

An example of such a rotary press machine is a rotary press machine designated as 102i Laboratory Tablet Press manufactured by Fette GmbH.

Another example is disclosed in U.S. Pat. No. 6,761,554, which discloses a rotary press machine including a press turret with upper and lower carousels in which upper and lower punch assemblies are removably supported. The punch assemblies include a die portion having a material chamber in which the material to be compressed is delivered.

In prior art rotary press machines, if they are loaded with tooling and powder material, during every revolution of the press turret (regardless of the operating parameters thereof), at least one compact (i.e., tablet) is produced from each die. This unavoidably leads to a waste of powder material during set-up or start-up of the machine as well as during shut down of the machine, since tablets produced at that time are made at a slower speed, or otherwise in the presence of one or more other non-acceptable operating parameters, and thus are invariably imperfect and must be discarded. This drawback is especially significant when rotary press machines are used for research and development purposes at the stage of a new formulation development because in such situations, there is usually only a limited amount of powder material available. Waste of such powder material is therefore an extremely significant problem.

One solution to the above problem is described in US Pub. Appln. No. 2009/0115090 A1, incorporated by reference herein. In this arrangement, one can selectively control the tableting process on a running press with a lower punch height adjustment mechanism that prevents powder from filling dies when tablet compaction is not needed and allows filling a die (or dies) whenever it is desired. This reduces and possibly eliminates waste of powder material being fed into dies of the rotary press machine during set-up, start-up, and shut-down stages, or otherwise when the rotary press machine is not at acceptable operating conditions, so that substantially all of the powder material can be fed into the dies under optimal tablet formation conditions.

The adjustment mechanism enables selective formation of the cavities in the dies. When cavities are formed, the feeding system is able to feed powder material into the dies and when cavities are not formed, the feeding system does not feed powder material into the dies.

The cavities are selectively formed based on the position of the lower punches relative to the dies. Thus, the vertical position or height of the lower punches is controlled by the adjustment mechanism to either close the opening of the dies and prevent cavity formation, or allow formation of a cavity. Control of the vertical position of the lower punches is achieved using a disengageable lowering cam. The lowering cam is engaged when tablet formation is desired and disengaged when tablet formation is not desired. This enables tablet formation only during optimal conditions, which will increase the likelihood of acceptable tablets being formed and thereby optimize tablet formation.

A related method for controlling a rotary press machine to optimize tablet formation includes rotating pairs of upper and lower punches sequentially through a feeding stage in which powder material is fed into a cavity selectively formed in a die by the lower punch, a pressing stage in which the upper and lower punches are pressed together and a tablet ejection stage in which a tablet formed in the die is ejected, feeding powder material into each die only when a cavity is formed in the die. When the cavities are not formed, powder material cannot be fed into the dies. The selective formation of the cavities may be accomplished by selectively adjusting a position of each lower punch relative to its respective die such that the lower punch either forms a cavity in the die or closes an opening of the die thereby preventing formation of a cavity in the die. As such, cavities can be formed and compacts made only when the tablet formation optimized and/or needed.

The tablet formation system of US 2009/0115090 allows compacting individual tablets as well as sets of tablets on rotary press machines. In that system, the original lowering cam is replaced with a power-driven device called a height (lower punch position) adjustment mechanism that features a movable punch head guide (also called moving guides) that can be selectively engaged or disengaged with the punches. When the movable punch head guide is disengaged, the lower punches stay in their upper (ejection) positions preventing the material from filling the dies and no tablets are being compacted.

The tablet formation system of US 2009/0115090 can be employed on rotary press machines for setup, research and development (R&D) purposes. It allows using a rotary press when a very small amount of powder is available. The setup, starting and stopping the press can be done without loss of powder. When individual tablets are compacted on an instrumented rotary press, the measured parameters can be specified for each of them.

When the rotary press is in the running mode, the movable guide cannot be engaged with a row of punches that are in their upper positions because such an attempt to engage the guide would interfere with the punch heads. This does not create a problem when using the tablet formation system on R&D machines when a relatively small number of tablets are being made, typically due to a small quantity of material being available. In R&D tablet formation, the machines are usually not fully loaded with tooling and the engagement/disengagement can be performed when the guide is facing an unloaded portion of the turret. However, using the same design on production machines would require removal of several punches and would result in a loss of productivity. The present invention is directed to this aspect.

### SUMMARY OF THE INVENTION

According to the present invention, the tablet formation system proposed for fully loaded machines comprises a lower punch height positioning system (also called herein an auxiliary system) which may be used together with the height adjustment system of US 2009/0115090. For reference herein, the height adjustment system of US 2009/0115090 will sometimes be called the “main” height adjustment system.

Also, the present tablet formation system features a plurality of lower punches equipped with removable rings. The rings can be attached to the punch barrels at the area between the die table and the lower turret where the lower punch barrels are exposed. When engaged, the auxiliary device interacts with the rings to control movement of the lower punches up and down, whereas the main device interacts with the punch head rims at the bottom of the lower punches.

The auxiliary device can be switched from a disengaged to an engaged position when its guide is facing lower punches which do not have rings installed. When the ringed lower punches reach the engaged auxiliary device and travel along its guide their heads get aligned with the profile of the main device guide, as the profile of the auxiliary device guide and the profile of the main device guide are identical. Because the auxiliary device guide has aligned the lower punches to the same profile as for the main device guide, the main device can now also be moved from a disengaged to an engaged position. All identifications, commands, and motions are electronically synchronized.

In another form of the invention, individual tablets can be produced on a fully loaded machine equipped with the tablet formation system using the auxiliary device and at least one additional lower punch equipped with a removable ring.

The present invention provides a rotary press machine comprising a plurality of pairs of upper and lower punches; a plurality of dies, each of said lower punches being moveable in a respective one of said dies to selectively enable formation of a cavity in said die; a feeding system for feeding powder material into said cavities of said dies in a feeding stage, said feeding stage being arranged to feed the powder material into each of said dies only when said die forms a cavity; a pressing system for pressing said upper and lower punches together in a pressing stage; a tablet ejection system for ejecting formed tablets from said dies in a tablet-ejection stage, said pairs of upper and lower punches being rotated sequentially through said feeding stage, and pressing stage, and said tablet-ejection stage; and an adjustment mechanism for enabling formation of at least one cavity in a die associated with a lower punch comprising a ring attached to the associated lower punch, and an engageable positioning guide to engage the ring and lower the lower punch to form a cavity when engaged, to thereby enable formation of a tablet.

The invention also provides, in a rotary press machine including a plurality of pairs of upper and lower punches, a plurality of dies, each of the lower punches being movable in a respective one of the dies to selectively enable formation of a cavity in said die, a feeding system for feeding powder material into the cavities of the dies in a feeding stage, a pressing system for pressing said upper and lower punches together in a pressing stage, a tablet ejection system for ejecting formed tablets from the dies in a tablet ejection stage, the pairs of upper and lower punches being rotated sequentially through the feeding stage, the pressing stage and the tablet ejection stage, the feeding system being arranged to feed the powder material into the dies only when the die forms a cavity; and an adjustment mechanism for enabling selective formation of the cavities in the dies such that when the cavities are formed, the feeding system is able to feed powder material into the dies and when the cavities are not formed, the feeding system does not feed powder material into the dies, the improvement comprising wherein said adjustment mechanism comprises a ring attached to a lower punch, and a selectively engageable positioning guide to engage the ring and lower the lower punch to form a cavity when engaged, to thereby enable formation of a tablet.

The invention provides a method for controlling a rotary press machine to optimize tablet formation, comprising rotating at least one pair of upper and lower punches sequentially through a feeding stage in which powder material is fed into a cavity selectively formed in a die by the lower punch, a pressing stage in which the upper and lower punches are pressed together and a tablet ejection stage in which a tablet formed in the die is ejected, feeding powder material into each die only when the die forms a cavity, and selectively forming a cavity in the die such that when the cavity is formed, powder material is fed into the die and when the cavity is not formed, powder material cannot be fed into the die, the cavity being formed by providing a ring on the lower punch, and by selectively engaging the lower punch ring to lower the lower punch to thereby form a cavity in the die to enable tablet formation.

The invention provides a rotary press machine for enabling selective cavity and tablet formation in a fully-loaded machine, comprising a die table defining a plurality of dies, a plurality of paired upper and lower punches associated with the plurality of dies, each of said lower punches being moveable in a respective one of said dies to enable formation of a cavity in said die, a feeding system for feeding powder material into said cavities at a feeding stage, a pressing system for pressing the pairs of upper and lower punches together at a pressing stage, a tablet system for ejecting formed tablets from said dies at a tablet ejection stage, wherein said pairs of upper and lower punches are rotated sequentially through said feeding stage, pressing stage, and tablet ejection stage, and an adjustment mechanism for enabling formation of cavities associated with selected pairs of lower and upper punches comprising a ring attached to each of a plurality of consecutive lower punches, and an engageable positioning guide to engage each of said rings to lower the lower punches and form a cavity when engaged, to thereby enable formation of tablets from said cavities.

The invention provides a rotary press machine, comprising a plurality of pairs of upper and lower punches, a plurality of dies, each of said lower punches being movable in a respective one of said dies to selectively enable formation of a cavity in said die, a feeding system for feeding powder material into said cavities of said dies in a feeding stage, said feeding system being arranged to feed the powder material into each of said dies only when said die forms a cavity, a pressing system for pressing said upper and lower punches together in a pressing stage, a tablet ejection system for ejecting formed tablets from said dies in a tablet ejection stage, said pairs of upper and lower punches being rotated sequentially through said feeding stage, said pressing stage and said tablet ejection stage, and an adjustment mechanism for enabling selective formation of said cavities by said dies such that when said cavities are formed, said feeding system is able to feed powder material into said dies and when said cavities are not formed, said feeding system does not feed powder material into said dies, said adjustment mechanism comprising a main adjustment device operable to selectively engage a first portion of a selected lower punch to form a cavity, and an auxiliary adjustment operable to engage a second portion of a selected lower punch different from said first portion to form a cavity.

The invention provides a method for controlling a rotary press machine to optimize tablet formation, comprising rotating at least one pair of upper and lower punches sequentially through a feeding stage in which powder material is fed into a cavity selectively formed in a die by the lower punch, a pressing stage in which the upper and lower punches are pressed together and a tablet ejection stage in which a tablet formed in the die is ejected, feeding powder material into each die only when the die forms a cavity, and selectively forming a cavity in the die such that when the cavity is formed, powder material is fed into the die and when the cavity is not formed, powder material cannot be fed into the die, the cavity being formed by engaging an auxiliary device to lower the lower punch ring, and engaging a main device to engage the lower punch rim.

### BRIEF DESCRIPTION OF THE DRAWINGS

The following drawings are illustrative of embodiments of rotary press machines and are not meant to limit the scope of the invention as encompassed by the claims.

FIG. 1 shows the various stages of the rotary press machine operating under optimal tablet formation conditions as tablets are being compacted.

FIG. 2 is a top view of the state of the lower punch height adjustment mechanism when the rotary press machine is operating under the conditions of FIG. 1.

FIG. 3 is a cross-sectional view showing the state of the lower punch height adjustment mechanism when the rotary press machine is operating under the conditions of FIG. 1, and which is taken along the line 3-3 of FIG. 2.

FIG. 4 shows the various stages of the rotary press machine operating under non-optimal tablet formation conditions as tablets are not being compacted.

FIG. 5 is a top view of the state of the lower punch height adjustment mechanism when the rotary press machine is operating under the conditions of FIG. 4.

FIG. 6 is a cross-sectional view showing the state of the lower punch height adjustment mechanism when the rotary press machine is operating under the conditions of FIG. 4, and which is taken along the line 6-6 of FIG. 5.

FIG. 7 is a top view of a tablet formation system for fully loaded presses according to the invention.

FIG. 8 is a side view of the system of FIG. 7, taken along line A-A of FIG. 7.

FIG. 9 is an end view of the system of FIGS. 7 and 8.

### DETAILED DESCRIPTION OF THE PREFERRED EMBODIMENT

A description of a preferred embodiment will be described, but the present invention is not limited to this embodiment.

The present invention provides a rotary press machine comprising a plurality of pairs of upper and lower punches; a plurality of dies, each of said lower punches being moveable in a respective one of said dies to selectively enable formation of a cavity in said die; a feeding system for feeding powder material into said cavities of said dies in a feeding stage, said feeding stage being arranged to feed the powder material into each of said dies only when said die forms a cavity; a pressing system for pressing said upper and lower punches together in a pressing stage; a tablet ejection system for ejecting formed tablets from said dies in a tablet-ejection stage, said pairs of upper and lower punches being rotated sequentially through said feeding stage, and pressing stage, and said tablet-ejection stage; and an adjustment mechanism for enabling formation of at least one cavity in a die associated with a lower punch comprising a ring attached to the associated lower punch, and an engageable positioning guide to engage the ring and lower the lower punch to form a cavity when engaged, to thereby enable formation of a tablet.

The ring may be removeably attached to the lower punch. The plurality of lower punches may be provided with rings attached to the lower punches to thereby form cavities associated with the lower punches having rings. The plurality of lower punches provided with rings may be consecutive or adjacent. The adjustment mechanism may be arranged to adjust a height of said lower punches relative to said feeding system such that only when desired, said height adjustment mechanism lowers said lower punches such that said lower punches enable formation of cavities by said dies and thus are receivable of powder material from said feeding system, and when not desired does not lower said lower punches such that said lower punches do not enable formation of said cavities by said dies and thus said dies do not receive powder material from said feeding system. The height adjustment mechanism may comprise a lowering cam arranged to selectively engage with said lower punches such that when said lowering cam engages with said lower punches, said lower punches are lowered, and when said lowering cam is disengaged from said lower punches, said lower punches are not lowered. The lowering cam may comprise at least one moving guide, said lower punches being arranged to movably engage with said at least one moving guide during rotation. The lower punches may each comprise an indentation and said at least one moving guide may each comprise a lip arranged relative to said lower punches such that said lip engages with said indentation and causes said lower punches to slide along said lip, said lip being angled in a direction away from said feeding system. The moving guide may be movable in a radial direction into or out of a position in which said lower punches engage therewith. The rotary press machine may further comprise an actuator for moving said at least one moving guide. One or both of the moving guides may have an arcuate form. The moving guide may comprise a lip arranged relative to the ring of a lower punch such that said lip engages with the ring and causes the lower punch to slide along said lip, said lip being angled in a direction away from said dies. The moving guide may be moveable in an inward radial direction into a position in which a ring of a lower punch engages therewith, and in an outward radial direction into a position in which the ring of a lower punch is unable to engage therewith. The machine may further comprise an actuator for moving the moving guide into and out of engagement.

The invention also provides, in a rotary press machine including a plurality of pairs of upper and lower punches, a plurality of dies, each of the lower punches being movable in a respective one of the dies to selectively enable formation of a cavity in said die, a feeding system for feeding powder material into the cavities of the dies in a feeding stage, a pressing system for pressing said upper and lower punches together in a pressing stage, a tablet ejection system for ejecting formed tablets from the dies in a tablet ejection stage, the pairs of upper and lower punches being rotated sequentially through the feeding stage, the pressing stage and the tablet ejection stage, the feeding system being arranged to feed the powder material into the dies only when the die forms a cavity; and an adjustment mechanism for enabling selective formation of the cavities in the dies such that when the cavities are formed, the feeding system is able to feed powder material into the dies and when the cavities are not formed, the feeding system does not feed powder material into the dies, the improvement comprising wherein said adjustment mechanism comprises a ring attached to a lower punch, and a selectively engageable positioning guide to engage the ring and lower the lower punch to form a cavity when engaged, to thereby enable formation of a tablet.

The height adjustment mechanism may comprise a lowering cam arranged to selectively engage with the lower punches such that when said lowering cam engages with the ring of a lower punch, the lower punches are lowered, and when said lowering cam is disengaged from the ring of a lower punch, the lower punch is not lowered. The lowering cam may comprise at least one moving guide, the lower punches being arranged to movably engage with said at least one moving guide during rotation.

The invention provides a method for controlling a rotary press machine to optimize tablet formation, comprising rotating at least one pair of upper and lower punches sequentially through a feeding stage in which powder material is fed into a cavity selectively formed in a die by the lower punch, a pressing stage in which the upper and lower punches are pressed together and a tablet ejection stage in which a tablet formed in the die is ejected, feeding powder material into each die only when the die forms a cavity, and selectively fowling a cavity in the die such that when the cavity is formed, powder material is fed into the die and when the cavity is not formed, powder material cannot be fed into the die, the cavity being formed by providing a ring on the lower punch, and by selectively engaging the lower punch ring to lower the lower punch to thereby form a cavity in the die to enable tablet formation.

The step of selectively forming a cavity may comprise forming the cavity only when the upper and lower punches are rotating at a normal production speed.

The invention provides a rotary press machine for enabling selective cavity and tablet formation in a fully-loaded machine, comprising a die table defining a plurality of dies, a plurality of paired upper and lower punches associated with the plurality of dies, each of said lower punches being moveable in a respective one of said dies to enable formation of a cavity in said die, a feeding system for feeding powder material into said cavities at a feeding stage, a pressing system for pressing the pairs of upper and lower punches together at a pressing stage, a tablet system for ejecting formed tablets from said dies at a tablet ejection stage, wherein said pairs of upper and lower punches are rotated sequentially through said feeding stage, pressing stage, and tablet ejection stage, and an adjustment mechanism for enabling formation of cavities associated with selected pairs of lower and upper punches comprising a ring attached to each of a plurality of consecutive lower punches, and an engageable positioning guide to engage each of said rings to lower the lower punches and form a cavity when engaged, to thereby enable formation of tablets from said cavities.

The rings may be removably attached to the lower punches. The adjustment mechanism may be arranged to adjust a height of said lower punches relative to said feeding system such that only when desired, said height adjustment mechanism lowers said lower punches such that said lower punches enable formation of cavities by said dies and thus are receivable of powder material from said feeding system, and when not desired does not lower said lower punches such that said lower punches do not enable formation of said cavities by said dies and thus said dies do not receive powder material from said feeding system. The height adjustment mechanism may comprise a lowering cam arranged to selectively engage with said lower punches such that when said lowering cam engages with said lower punches, said lower punches are lowered, and when said lowering cam is disengaged from said lower punches, said lower punches are not lowered. The lowering cam may comprise at least one moving guide, said lower punches being arranged to movably engage with said at least one moving guide during rotation. The lower punches may each comprise an indentation and said at least one moving guide each comprises a lip arranged relative to said lower punches such that said lip engages with said indentation and causes said lower punches to slide along said lip, said lip being angled in a direction away from said feeding system. The at least one moving guide may be movable in a radial direction into or out of a position in which said lower punches engage therewith. The machine may further comprise an actuator for moving said at least one moving guide. Each of said at least one moving guide may have an arcuate form. The moving guide may comprise a lip arranged relative to the ring of a lower punch such that said lip engages with the ring and causes the lower punch to slide along said lip, said lip being angled in a direction away from said dies. The moving guide may be moveable in an inward radial direction into a position in which a ring of a lower punch engages therewith, and in an outward radial direction into a position in which the ring of a lower punch is unable to engage therewith. The rotary press machine may further comprise an actuator for moving the moving guide into and out of engagement.

The invention provides a rotary press machine, comprising a plurality of pairs of upper and lower punches, a plurality of dies, each of said lower punches being movable in a respective one of said dies to selectively enable formation of a cavity in said die, a feeding system for feeding powder material into said cavities of said dies in a feeding stage, said feeding system being arranged to feed the powder material into each of said dies only when said die forms a cavity, a pressing system for pressing said upper and lower punches together in a pressing stage, a tablet ejection system for ejecting formed tablets from said dies in a tablet ejection stage, said pairs of upper and lower punches being rotated sequentially through said feeding stage, said pressing stage and said tablet ejection stage, and an adjustment mechanism for enabling selective formation of said cavities by said dies such that when said cavities are formed, said feeding system is able to feed powder material into said dies and when said cavities are not formed, said feeding system does not feed powder material into said dies, said adjustment mechanism comprising a main adjustment device operable to selectively engage a first portion of a selected lower punch to form a cavity, and an auxiliary adjustment operable to engage a second portion of a selected lower punch different from said first portion to form a cavity.

The main adjustment device may be operable to engage a lower rim portion of the lower punch. The auxiliary adjustment device may be operable to engage an upper portion of the lower punch equipped with a ring. The ring may be removeable. The main adjustment device and auxiliary adjustment device may be separately and independently engageable and disengageable with said lower punches.

The invention provides a method for controlling a rotary press machine to optimize tablet formation, comprising rotating at least one pair of upper and lower punches sequentially through a feeding stage in which powder material is fed into a cavity selectively formed in a die by the lower punch, a pressing stage in which the upper and lower punches are pressed together and a tablet ejection stage in which a tablet formed in the die is ejected, feeding powder material into each die only when the die forms a cavity, and selectively forming a cavity in the die such that when the cavity is formed, powder material is fed into the die and when the cavity is not formed, powder material cannot be fed into the die, the cavity being formed by engaging an auxiliary device to lower the lower punch ring, and engaging a main device to engage the lower punch rim.

The auxiliary device may pre-positions the lower punch into a selected position before the main device is engaged and the method may further comprise the step of disengaging the auxiliary device after the main device is engaged. The step of rotating may comprise rotating a plurality of pairs of upper and lower punches. The auxiliary device may engage a lower punch ring at a first region and the main device may engage the lower punch ring at a second region. The auxiliary device may engage a ring on the lower punch. The ring may be removeable. The plurality of pairs of upper and lower punches may be adjacent each other. The plurality of lower punches may be adjacent each other and provided with rings.

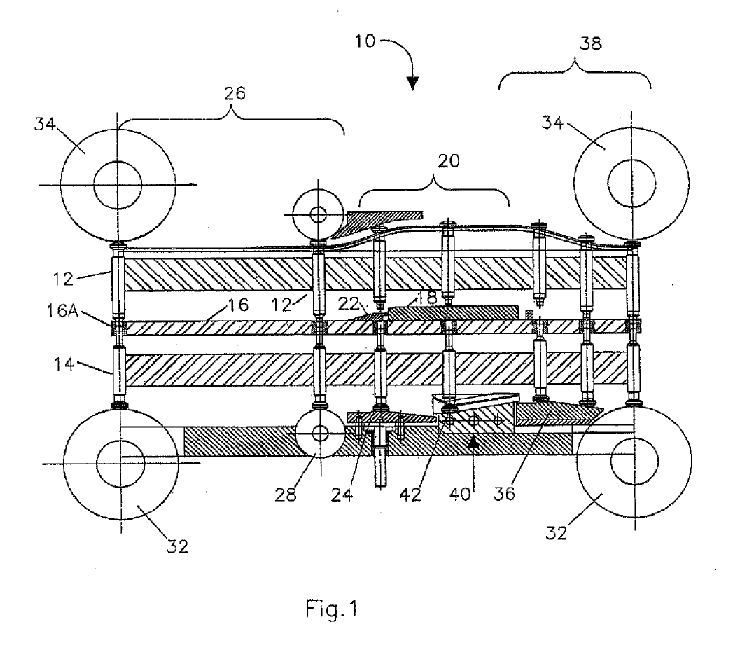

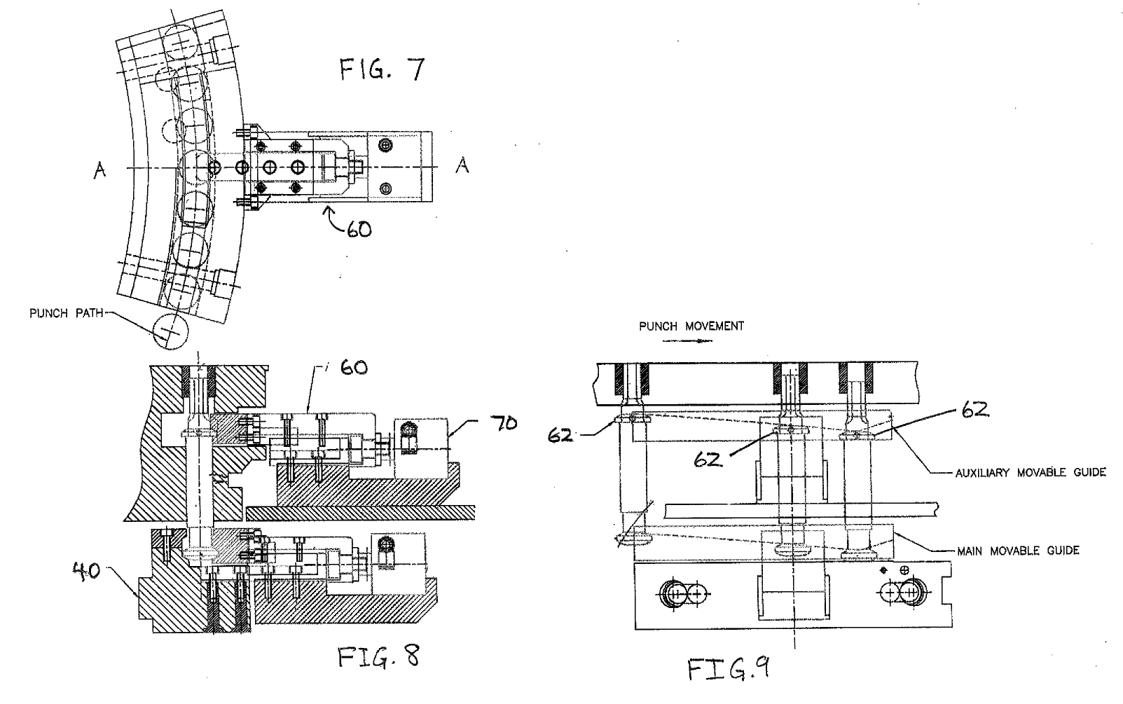

FIGS. 1-6 show the tablet formation system according to US 2009/0115090 as a background and as an aid to understanding an embodiment according to the present invention, and may also be used in combination with the system of the present invention. FIGS. 7-9 show a preferred embodiment of a tablet formation arrangement according to the present invention.

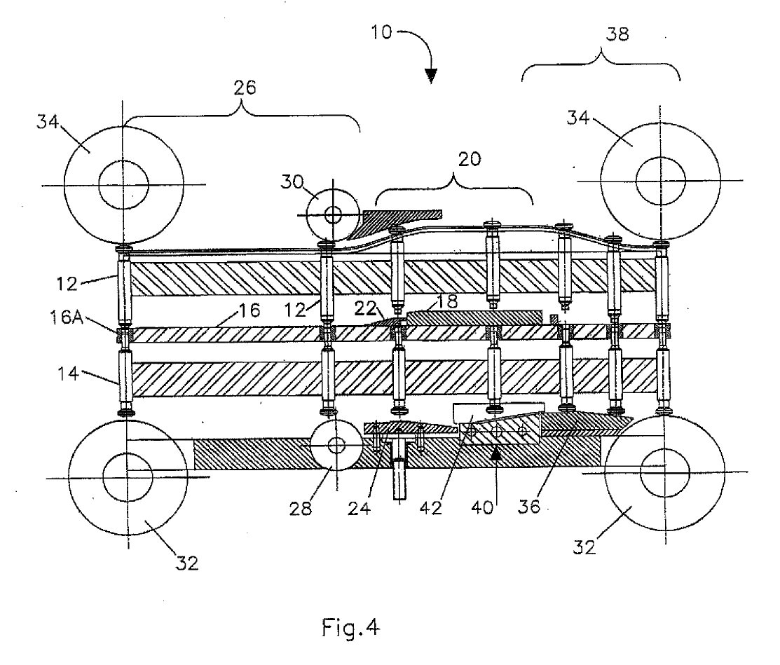

FIGS. 1 and 4 show an example of a rotary press machine 10 which is capable of compacting individual tablets as well as large batches at production speeds, and to which the system and method in accordance with US 2009/0115090 have been applied. The system and method can be applied to different rotary press machines regardless of their particular design.

A principle concept of US 2009/0115090 is to prevent powder material from being filled into the dies in a rotary press machine at the feeding stage when it is not desired, and to permit a feeding mechanism to feed powder material into dies only when it is desired. In this manner, the quantity of powder material spent to form tablets is optimized with little or no waste of tablets. In prior art rotary press machines, a lowering cam is always engaged with the passing lower punches moving them down and creating cavities in the dies that are filled with the powder.

This concept will be explained with reference to FIGS. 1 and 4, which includes a plurality of pairs of upper punches 12 and lower punches 14, and a die table 16 on which lower punches 14 are guided in each die 16A. The lower punch 14 moves vertically relative to each die 16A to selectively define a cavity in the die 16A into which powder material can be filled, i.e., a powder material to form a tablet upon subsequent pressing of the upper and lower punches 12, 14 together. The upper and lower punches 12, 14 and die 16A are rotated by a rotation system (not shown), which is standard for rotary press machines. FIGS. 1 and 4 are views of the circumference of the rotary press machine 10 wherein the upper and lower punches 12, 14 are rotated in a direction from right to left.

The rotary press machine 10 includes a feeding system 18 for feeding powder material into the dies 16A in a feeding stage 20. The feeding system 18 is arranged to feed the powder material into each die 16A when the tip of a lower punch 14 is lower than the upper level of the die 16A. The vertical position of the lower punches 14 relative to the dies 16A is controlled by engaging or disengaging a lowering cam 42 of the design. The feeding system 18 can be any known feeding system, mechanism, arrangement, or assembly used to fill material into dies, including but not limited to a feeder and a hopper.

A material scraper 22 is arranged after the feeding mechanism 18 in the direction of rotation of the upper and lower punches 12, 14 and scrapes excess powder material from the dies 16A. A depth-of-fill adjustment mechanism 24 adjusts the height of the lower punches 14 to provide a desired level of powder material in the dies 16A before tablet compaction. The depth-of-fill mechanism 24 and material scraper 22 are situated at the beginning of a tableting stage 26 in which the upper and lower punches 12, 14 are pressed together, with a die therebetween, by a pair of pre-pressure rolls 28, 30 and then by main pressure rolls 32, 34 (shown twice in FIG. 1 since the illustration is of the circumference of the rotary press machine 10). Instead of the pre-pressure rolls 28, 30 and the main pressure rolls 32, 34, other pressing systems, mechanisms, arrangements or assemblies for pressing the upper and lower punches 12, 14 together with the die therebetween in a pressing stage may be applied.

A tablet ejection system 36 is arranged in a tablet ejection stage 38 after the tableting stage 26 in the direction of rotation of the upper and lower punches 12, 14. The tablet ejection system 36 may be any known system, mechanism, arrangement, or assembly which is capable of ejecting or otherwise removing a tablet from a die. The tablet ejection system 36 is a tablet ejection cam which raises the lower punches 14 relative to the die table 16 to thereby push the formed tablet out of the die.

In operation, the upper and lower punches 12, 14 are rotated sequentially through the feeding stage 20, the tableting stage 26 and the tablet ejection stage 38 by a known rotation system (not shown) which is usually coupled to the upper and lower punches 12, 14. The rotation system provides variable speeds of rotation of the upper and lower punches 12, 14. Thus, once the rotary press machine 10 is started, the rotation system begins to rotate the upper and lower punches 12, 14, gradually increasing the speed during set-up and start-up of the rotary press machine 10 until a predetermined, normal production speed is achieved. Once this normal production speed is achieved, the rotation system maintains this speed until production of tablets is to cease. At this time, the rotation mechanism reduces the speed until the upper and lower punches 12, 14 are stationary, i.e., shut-down. The operator of the rotary press machine determines the normal production speed in a manner known to those skilled in the art.

To avoid the formation of imperfect tablets which occurs if the rotary press machine 10 operates at rotation speeds other than the predetermined, normal production speed, i.e., during the set-up, start-up and shut-down stages when the rotation speeds is increasing to or decreasing from the normal, production speed, and make it possible to produce individual tablets or batches on a running press equipped with single or multiple sets of tooling, a height adjustment system 40 is provided to adjust the vertical position or height of the lower punches 14 relative to the feeding system 18, to thereby selectively form or prevent formation of powder material-receiving cavities in the dies. Height adjustment system 40 is operated such that only when it is necessary or desired, the lower punches 14 are lowered such that the dies 16A therein are open and powder material-receiving cavities are formed, and thus are receivable of powder material from the feeding system 18 (see FIG. 1). On the other hand, the height adjustment system 40 can be controlled such that the lower punches 14 being restrained with punch clips 59 maintain the highest vertical position they have reached when passing the tablet ejection cam of the tablet ejection system 36 and the openings of the dies are closed with the tips of the lower punches 14 (see FIG. 4). This prevents formation of a powder material-receiving cavity in each die. As such, the dies cannot receive powder material from the feeding system 18.

By selectively adjusting the height of the lower punches 12, 14 in the foregoing manner, the use of the powder material can be optimized and filled into the dies only when the rotational speed of the upper and lower punches 12, 14 is an acceptable or normal production speed which would almost assuredly provide acceptable tablets.

The height adjustment mechanism 40 includes a lowering cam 42 arranged to selectively engage with the lower punches 14. The lowering cam 42 has an engaged position in which it engages with the lower punches 14 to cause the lower punches 14 to be lowered such that the dies in the lower punches 14 are open and form powder material-receiving cavities (shown in FIGS. 1-3), and a disengaged position in which the lowering cam 42 is disengaged from the lower punches 14 (shown in FIGS. 4-6). In the disengaged position, the lower punches 14 are not lowered and therefore, the dies in the lower punches 14 are closed by the lower punches 14 and thus do not form powder material-receiving cavities and therefore cannot receive powder material from the feeding system 18.

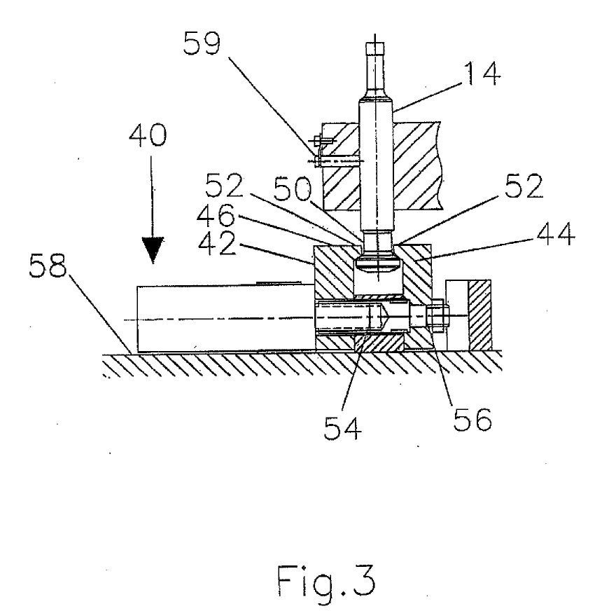

Various forms of the lowering cam 42 are possible. In one form, the lowering cam 42 includes a pair of moving guides 44, 46, also referred to as movable punch head guides, arranged opposite one another to define a channel 48 therebetween through which an annular indentation or indented portion 50 of the lower punches 14 pass during their rotation in the rotary press machine 10 (see FIG. 3).

The moving guides 44, 46 include a lip 52 arranged relative to the lower punches 14 such that contact between the lip 52 and the indented portion 50 of the lower punches 14 causes the lower punches 14 to slide along the lip 52 during their rotation (see FIG. 3). The vertical displacement of the lower punches 14 in a direction away from the fill level, i.e., the upper surface of the dies 16A, is therefore achieved by appropriate angling of the lip 52 in a direction away from the fill level (see FIG. 1).

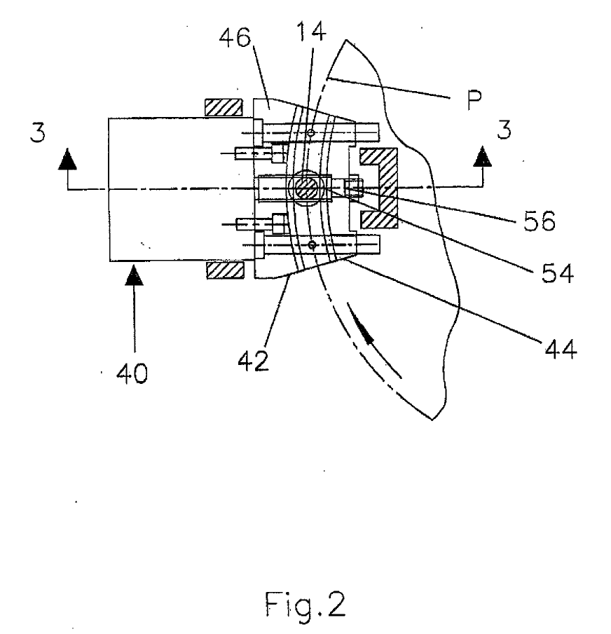

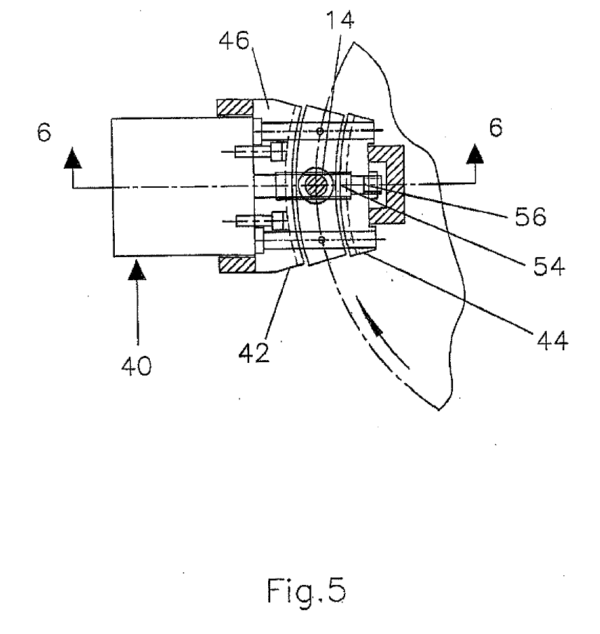

Further, the moving guides 44, 46 have an arcuate form as shown in FIGS. 2 and 5. This arcuate form enables the lower punches 14 to be rotated therethrough as they are rotated around the rotary press machine 10 by its rotation mechanism.

To move between engaged and disengaged positions, the moving guides 44, 46, are movable in a radial direction into or out of a position in which the lower punches 14 can engage therewith. Moving guide 44 is arranged inward of channel 48 and moving guide 46 and is therefore moved radially outward to its engaged position and then radially inward to its disengaged position. Conversely, since moving guide 46 is arranged outward of channel 48 and moving guide 44, it is moved radially inward to its engaged position and then radially outward to its disengaged position.

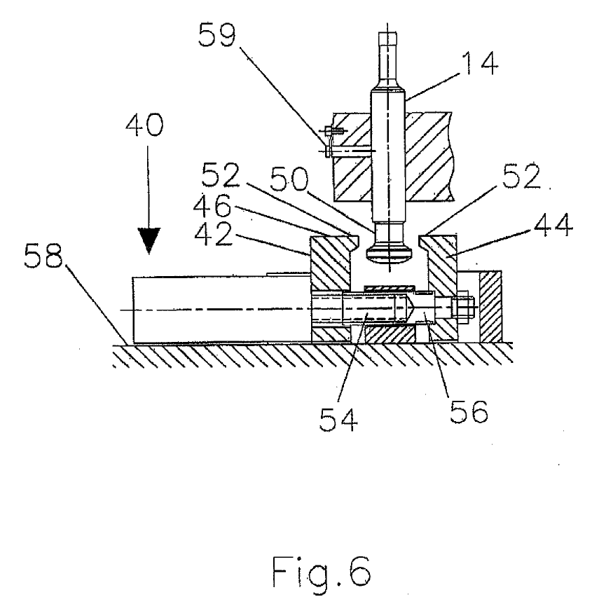

Movement of the moving guides 44, 46 between their engaged and disengaged positions may be achieved using any known movement mechanism. For example, an actuator 54 is shown coupled to the moving guides 44, 46 and which brings the moving guides 44, 46 together into their engaged positions and separates them into their disengaged positions. The actuator 54 is mounted to a table 58 or other fixed portion of the rotary press machine 10. Further, the actuator 54 may be a hydraulic air actuator and the like. When a rod 56 of the actuator 54 is retracted as shown in FIG. 3, the moving guides 44, 46 are in their engaged positions and when the rod 56 is extended as shown in FIG. 6, the moving guides 44, 46 are in their disengaged positions.

Both moving guides 44, 46 are movable by actuator 54, for example, to provide the lowering cam 42 with its engaged and disengaged positions. However, only one of the moving guides 44 or 46 is movable and the other is fixed. In this case, movement of the single moving guide 44 or 46 serves to provide the lowering cam 42 with its engaged and disengaged positions.

The engagement or disengagement of the lowering cam 42 can be controlled based on several factors. Importantly, it is based on the rotational speed of the rotary press machine 10 as mentioned above so that once the rotational speed is a speed which will almost ensure acceptable tablet formation, the lowering cam 42 is engaged by the actuator 54. Another parameter is the force of the upper and lower punches 12, 14. In this case, the force of the upper and lower punches 12, 14 can be determined and if inadequate to ensure formation of acceptable tablets, the lowering cam 42 will not be engaged or will be disengaged if already engaged. Control of the lowering cam 42 may also be based on analysis of the tablets being formed, e.g., their thickness, or the operation of the machine, e.g., the movement of the upper and lower punches 12, 14, so that whenever an operator or a computer control unit determines that the conditions for tablet formation are not optimal, the lowering cam 42 will not be engaged or will be disengaged if already engaged.

The height adjustment mechanism 40 is operative to selectively adjust the height of the lower punches 14 relative to the feeding system 18, so that powder material can or cannot be filled into the dies in the lower punches 14 (e.g., depending on the rotational speed of the rotary press machine 10 as described above). Another embodiment is contemplated wherein the difference in height between the dies 16A in the lower punches 14 at the feeding stage 20 and the outlet of the feeding system 18 is selectively adjusted and controlled by varying the location of the feeding system 18. In such an embodiment, the lower punches 14 would not be vertically displaced but rather the feeding system 18 would be separated from the dies, e.g., by an actuator coupled thereto, so that when the rotational speed of the rotary press machine 10 is a normal production speed, there is an opening between the outlet of the feeding system 18 and the dies 16A in the lower punches 14 (so that powder material is filled into cavities formed in the dies 16A) and when the rotational speed of the rotary press machine 10 is below a normal production speed, there is no opening between the outlet of the feeding system 18 and the dies 16A in the lower punches 14 (so that powder material cannot be filled into cavities formed in the dies 16A).

In such a movable feeding system, either the entire feeding system may be movable relative to the dies or only the outlet of the feeding system. The feeding system may take the form of a feeder or a hopper.

A rotary press machine 10 including a height adjustment mechanism 40 in any of its forms described above may be used for set-up, research and development purposes, and serve as a basis for creating rotary type compaction simulators that would allow producing individual tablets as well as batches at high production speeds.

The operating system of the rotary press machine 10 (not shown) may be coupled to the various controlled components including the rotation mechanism, the feeding system 18, and the height adjustment mechanism 40. The operating system provides an input interface to allow an operator to control the operation of the rotary press machine 10. The operator may therefore input a “make a tablet” command to cause the operating system to enable the rotary press machine 10 to initiate formation of a single tablet. Specifically, upon receipt of such a command, the operating system engages the lowering cam 42 to cause the actuator 54 to bring the moving guides 44, 46 into their engaged positions and thus a lower punch 14 to be downwardly vertically displaced away from the fill level such that the lower punch 14 does not close the opening of the die 16A and thereby forming a cavity in the die 16A and permitting powder material to be placed into the formed cavity in the die 16A from the feeding system 18. Thereafter, the actuator 54 is directed to move the moving guides 44, 46 to their disengaged positions. The operating system synchronizes the control commands to the actuator 54 with the position of the lower punch 14 relative to the lowering cam 42.

If the operator inputs a “make a batch” command, the operating system enables the rotary press machine 10 to initiate formation of a batch of tablets. In this case, the operating system engages the lowering cam 42 to cause the actuator 54 to bring the moving guides 44, 46 into their engaged positions and thus lower punches 14 to be downwardly vertically displaced away from the fill level such that they do not close the opening of the dies 16A and form cavities in the dies 16A permitting powder material to be placed into the cavities in the dies 16A from the feeding system 18. After the designated number of tablets has been formed, the actuator 54 is directed to move the moving guides 44, 46 to their disengaged positions. The operating system synchronizes the control commands to the actuator 54 with the position of the lower punches 14 relative to the lowering cam 42.

The rotary press machine 10 can therefore be controlled to make individual tablets or a batch of tablets from the powder material being provided to the feeding system 18. An operator thus is provided with increased flexibility when forming tablets from limited amounts of powder material, e.g., during research and development uses of the rotary press machine 10. When the operating conditions of the rotary press machine 10 are determined by the operator, or by sensors, not to be optimal for formation of acceptable tablets, the operator does not issue the “make a tablet” or “make a batch” commands.

The height adjustment mechanism 40 may be included in a new rotary press machine 10 or may be applied as a retrofit of an existing rotary oppress machine. In the latter case, the height adjustment mechanism 40 would be arranged in the rotary press machine in consideration of the position of the feeding system in such a machine and coupled to the operating system of the machine. The height adjustment mechanism 40 would function to control the height difference or separation between the outlet of the feeding system and the lower punches so that it is possible to have the lower punches selectively close the opening of the dies and thereby prevent filling of powder material into the dies.

The tablet formation system of US 2009/0115090 as described above can be employed on rotary press machines for setup, research and development (R&D) purposes. It allows using a rotary press when a very small amount of powder is available. The setup, starting and stopping the press can be done without loss of powder. When individual tablets are compacted on an instrumented rotary press, the measured parameters can be specified for each of them.

When the rotary press is in the running mode, the movable guide cannot be engaged with a row of punches that are in their upper positions because such an attempt to engage the guide would interfere with the punch heads. This does not create a problem when using the tablet formation system on R&D machines when a relatively small number of tablets are being made, typically due to a small quantity of material being available, because in R&D tablet formation, the machines are usually not fully-loaded with tooling and the engagement/disengagement can be performed when the guide is facing an unloaded portion of the turret (i.e., a portion of the turret which does not have lower punches installed). However, using the same design on production machines would require removal of several lower punches which would result in a loss of productivity, due to downtime of the machine, as well as labor to remove the lower punches.

The system of FIGS. 7-9 provides a way to convert a fully loaded production tableting system into a small batch or R&D tableting system, and back again, relatively easily and quickly, with very little downtime to the tableting system, without removing the fully loaded tooling of a full complement of lower punches used when the tablet press is run in a full-capacity, high volume, production mode.

According to the system of FIGS. 7-9, the tablet formation system proposed for fully loaded machines comprises a lower punch height positioning system 60 (also called herein an auxiliary device system) which may be used with the height adjustment system of US 2009/0115090. For reference herein, the height adjustment system of US 2009/0115090 will sometimes be called the “main” height adjustment system, compared to the lower punch height positioning system 60, sometimes called the auxiliary device or system 60.

In one form, the present system features a plurality of lower punches equipped with removable rings 62. The rings can be attached to the punch barrels at the area between the die table and the lower turret where the upper region of the lower punch barrels are exposed. When engaged, the auxiliary device or system 60 interacts with the rings 62 to control movement of the lower punches up and down, whereas the main height adjustment system 40 (when engaged) interacts with the punch head rims at the bottom of the lower punches to move the lower punches up and down.

The auxiliary system 60 can be moved laterally between engaged and disengaged positions relative to the die table and lower turret. The auxiliary system 60 can be moved from a disengaged to an engaged position when its guide is facing punches which do not have rings 62 installed. When the rimmed punches reach the engaged auxiliary device and travel along its guide their heads get aligned with the profile of the main device guide, as both guides are identical. Now the main device 40 can also be moved from a disengaged to an engaged position. All identifications, commands, and motions are electronically synchronized.

in another form of the invention, individual tablets can be produced on a fully-loaded machine (having lower punches in all, or substantially all of the lower punch positions) using the auxiliary device 60 and at least one additional lower punch equipped with a removable ring 62.

An exemplary embodiment of the tablet formation system for fully loaded rotary presses is shown on FIG. 7. The operation of using it, as well as a method of making tablets on production presses, is described as follows.

Before the press rotation is turned on, both the main device 40 and auxiliary device 60 are in disengaged positions laterally spaced from the turret. The number of lower punches equipped with rings should preferably be at least equal to the quantity of punches on the entire length of the lowering cam plus two. This will insure that the auxiliary device 60 will first align the heights of the lower punches equipped with rings to a selected position at their proper height so that the lower punches will be aligned with the lowering cam of the main device 40. Stated in another way, the auxiliary device 60, when engaged, pre-positions the lower punches to the proper height aligned with the lowering cam of the main device 40, so that the main device 40 can be engaged if desired without damaging the lower punches. The feed frame is filled with powder; the powder valve on the hopper is shut. Initial depth of fill and tablet thickness settings are installed as usually, based on the setup instructions or experience.

Sample tablets are compacted on the designated stations equipped with ringed lower punches (i.e., lower punches equipped with rings 62). During the first rotation of the turret after the press is turned on, the electronics check if rings are installed on lower punches on proper positions and only on proper positions of the turret. After that, the system is ready to accept commands.

When a command “Make samples” is sent, the lower actuator device 70 first engages the auxiliary device laterally into the turret, and then disengages it after the ringed punches are brought down to the overfill positions. The samples compacted in the filled dies can be used for measurements and testing. During the testing and subsequent adjustment of the press settings, the press is in a stand-by mode (rotation with no tablets being made, ready for the next command). When a new set of sample tablets is needed, the command repeats. If the intervals between samplings are long the press rotation can be stopped and then started again. Since both the main device 40 and auxiliary device 60 are disengaged, an operator may start and stop the rotary press with no loss of powder.

To complete the setup, it is possible to test a set of tablets produced on all stations. On “One rotation tableting” command, the auxiliary device 60 engages and aligns the heads of the rimmed punches with the profile of the main device guide. At this moment, the main device 40 engages. The auxiliary device 60 stays engaged. When, after one turret rotation, the ringed lower punches are aligned with the main device guide again, the main device 40 disengages. When the ringed lower punches are lowered to the overfill position the auxiliary device 60 also disengages.

On a command “Continues tableting”, the auxiliary device 60 engages and aligns the heads of the ringed punches with the profile of the main device guide. At this moment, the main device 60 engages. When the ringed punches are lowered to the overfill position the auxiliary device 60 disengages.

When a command “Stop” is sent, the auxiliary device engages to facilitate the disengagement of the main device and then disengages itself. Only after that, the command “Stop” is executed. This avoids any loss of powder material due to imperfect tablet compaction.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A rotary press machine comprising:
a plurality of pairs of upper and lower punches;
a plurality of dies, each of said lower punches being moveable in a respective one of said dies to selectively enable formation of a cavity in said die;
a feeding system for feeding powder material into said cavities of said dies in a feeding stage, said feeding stage being arranged to feed the powder material into each of said dies only when said die forms a cavity;
a pressing system for pressing said upper and lower punches together in a pressing stage;
a tablet ejection system for ejecting formed tablets from said dies in a tablet-ejection stage, said pairs of upper and lower punches being rotated sequentially through said feeding stage, and pressing stage, and said tablet-ejection stage; and
an adjustment mechanism for enabling formation of at least one cavity in a die associated with a lower punch comprising a ring attached to the associated lower punch, and an engageable positioning guide to engage the ring and lower the lower punch to form a cavity when engaged, to thereby enable formation of a tablet.

2. The rotary press machine of claim 1, wherein the ring is removeably attached to the lower punch.

3. The rotary press machine of claim 1 wherein
a plurality of lower punches are provided with rings attached to the lower punches to thereby form cavities associated with the lower punches having rings.

4. The rotary press machine of claim 3 wherein the plurality of lower punches provided with rings are consecutive.

5. The rotary press machine of claim 1, wherein
said adjustment mechanism is arranged to adjust a height of said lower punches relative to said feeding system such that only when desired, said height adjustment mechanism lowers said lower punches such that said lower punches enable formation of cavities by said dies and thus are receivable of powder material from said feeding system, and when not desired does not lower said lower punches such that said lower punches do not enable formation of said cavities by said dies and thus said dies do not receive powder material from said feeding system.

6. The rotary press machine of claim 5, wherein
said height adjustment mechanism comprises a lowering cam arranged to selectively engage with said lower punches such that when said lowering cam engages with said lower punches, said lower punches are lowered, and when said lowering cam is disengaged from said lower punches, said lower punches are not lowered.

7. The rotary press machine of claim 6, wherein
said lowering cam comprises at least one moving guide, said lower punches being arranged to movably engage with said at least one moving guide during rotation.

8. The rotary press machine of claim 7, wherein
said lower punches each comprise an indentation and said at least one moving guide each comprises a lip arranged relative to said lower punches such that said lip engages with said indentation and causes said lower punches to slide along said lip, said lip being angled in a direction away from said feeding system.

9. The rotary press machine of claim 7, wherein
said at least one moving guide is movable in a radial direction into or out of a position in which said lower punches engage therewith.

10. The rotary press machine of claim 9,
further comprising an actuator for moving said at least one moving guide.

11. The rotary press machine of claim 6, wherein
each of said at least one moving guides has an arcuate form.

12. The rotary press machine according to claim 7, wherein the moving guide comprises a lip arranged relative to the ring of a lower punch such that said lip engages with the ring and causes the lower punch to slide along said lip, said lip being angled in a direction away from said dies.

13. The rotary press machine according to claim 7, wherein
the moving guide is moveable in an inward radial direction into a position in which a ring of a lower punch engages therewith, and in an outward radial direction into a position in which the ring of a lower punch is unable to engage therewith.

14. The rotary press machine according to claim 7, further comprising an actuator for moving the moving guide into and out of engagement.

15. In a rotary press machine including a plurality of pairs of upper and lower punches, a plurality of dies, each of the lower punches being movable in a respective one of the dies to selectively enable formation of a cavity in said die, a feeding system for feeding powder material into the cavities of the dies in a feeding stage, a pressing system for pressing said upper and lower punches together in a pressing stage, a tablet ejection system for ejecting formed tablets from the dies in a tablet ejection stage, the pairs of upper and lower punches being rotated sequentially through the feeding stage, the pressing stage and the tablet ejection stage, the feeding system being arranged to feed the powder material into the dies only when the die forms a cavity; and an adjustment mechanism for enabling selective formation of the cavities in the dies such that when the cavities are formed, the feeding system is able to feed powder material into the dies and when the cavities are not formed, the feeding system does not feed powder material into the dies, the improvement comprising wherein said adjustment mechanism comprises a ring attached to a lower punch, and a selectively engageable positioning guide to engage the ring and lower the lower punch to form a cavity when engaged, to thereby enable formation of a tablet.

16. The rotary press machine of claim 15, wherein
said height adjustment mechanism comprises a lowering cam arranged to selectively engage with the lower punches such that when said lowering cam engages with the ring of a lower punch, the lower punches are lowered, and when said lowering cam is disengaged from the ring of a lower punch, the lower punch is not lowered.

17. The rotary press machine of claim 16, wherein
said lowering cam comprises at least one moving guide, the lower punches being arranged to movably engage with said at least one moving guide during rotation.

18. A method for controlling a rotary press machine to optimize tablet formation, comprising:
rotating at least one pair of upper and lower punches sequentially through a feeding stage in which powder material is fed into a cavity selectively formed in a die by the lower punch, a pressing stage in which the upper and lower punches are pressed together and a tablet ejection stage in which a tablet formed in the die is ejected;
feeding powder material into each die only when the die forms a cavity; and
selectively forming a cavity in the die such that when the cavity is formed, powder material is fed into the die and when the cavity is not formed, powder material cannot be fed into the die, the cavity being formed by providing a ring on the lower punch, and by selectively engaging the lower punch ring to lower the lower punch to thereby form a cavity in the die to enable tablet formation.

19. The method of claim 18, wherein
the step of selectively forming a cavity comprises forming the cavity only when the upper and lower punches are rotating at a normal production speed.

20. A rotary press machine for enabling selective cavity and tablet formation in a fully-loaded machine, comprising:
a die table defining a plurality of dies;
a plurality of paired upper and lower punches associated with the plurality of dies, each of said lower punches being moveable in a respective one of said dies to enable formation of a cavity in said die;
a feeding system for feeding powder material into said cavities at a feeding stage;
a pressing system for pressing the pairs of upper and lower punches together at a pressing stage;
a tablet system for ejecting formed tablets from said dies at a tablet ejection stage, wherein said pairs of upper and lower punches are rotated sequentially through said feeding stage, pressing stage, and tablet ejection stage; and
an adjustment mechanism for enabling formation of cavities associated with selected pairs of lower and upper punches comprising a ring attached to each of a plurality of consecutive lower punches, and an engageable positioning guide to engage each of said rings to lower the lower punches and form a cavity when engaged, to thereby enable formation of tablets from said cavities.

21. The rotary press machine of claim 20, wherein the rings are removably attached to the lower punches.

22. The rotary press machine of claim 20, wherein
said adjustment mechanism is arranged to adjust a height of said lower punches relative to said feeding system such that only when desired, said height adjustment mechanism lowers said lower punches such that said lower punches enable formation of cavities by said dies and thus are receivable of powder material from said feeding system, and when not desired does not lower said lower punches such that said lower punches do not enable formation of said cavities by said dies and thus said dies do not receive powder material from said feeding system.

23. The rotary press machine of claim 22, wherein
said height adjustment mechanism comprises a lowering cam arranged to selectively engage with said lower punches such that when said lowering cam engages with said lower punches, said lower punches are lowered, and when said lowering cam is disengaged from said lower punches, said lower punches are not lowered.

24. The rotary press machine of claim 23, wherein
said lowering cam comprises at least one moving guide, said lower punches being arranged to movably engage with said at least one moving guide during rotation.

25. The rotary press machine of claim 24, wherein
said lower punches each comprise an indentation and said at least one moving guide each comprises a lip arranged relative to said lower punches such that said lip engages with said indentation and causes said lower punches to slide along said lip, said lip being angled in a direction away from said feeding system.

26. The rotary press machine of claim 24, wherein
said at least one moving guide is movable in a radial direction into or out of a position in which said lower punches engage therewith.

27. The rotary press machine of claim 26,
further comprising an actuator for moving said at least one moving guide.

28. The rotary press machine of claim 23, wherein
each of said at least one moving guides has an arcuate form.

29. The rotary press machine according to claim 24, wherein
the moving guide comprises a lip arranged relative to the ring of a lower punch such that said lip engages with the ring and causes the lower punch to slide along said lip, said lip being angled in a direction away from said dies.

30. The rotary press machine according to claim 24, wherein
the moving guide is moveable in an inward radial direction into a position in which a ring of a lower punch engages therewith, and in an outward radial direction into a position in which the ring of a lower punch is unable to engage therewith.

31. The rotary press machine according to claim 24, further comprising an actuator for moving the moving guide into and out of engagement.

32. A rotary press machine, comprising:
a plurality of pairs of upper and lower punches;
a plurality of dies, each of said lower punches being movable in a respective one of said dies to selectively enable formation of a cavity in said die;
a feeding system for feeding powder material into said cavities of said dies in a feeding stage, said feeding system being arranged to feed the powder material into each of said dies only when said die forms a cavity;
a pressing system for pressing said upper and lower punches together in a pressing stage;
a tablet ejection system for ejecting formed tablets from said dies in a tablet ejection stage, said pairs of upper and lower punches being rotated sequentially through said feeding stage, said pressing stage and said tablet ejection stage; and
an adjustment mechanism for enabling selective formation of said cavities by said dies such that when said cavities are formed, said feeding system is able to feed powder material into said dies and when said cavities are not formed, said feeding system does not feed powder material into said dies, said adjustment mechanism comprising a main adjustment device operable to selectively engage a first portion of a selected lower punch to form a cavity, and an auxiliary adjustment operable to engage a second portion of a selected lower punch different from said first portion to form a cavity.

33. The rotary press machine of claim 32,
wherein the main adjustment device is operable to engage a lower rim portion of the lower punch.

34. The rotary press machine of claim 32,
wherein the auxiliary adjustment device is operable to engage an upper portion of the lower punch equipped with a ring.

35. The rotary press machine of claim 34,
wherein the ring is removeable.

36. The rotary press machine of claim 32,
wherein the main adjustment device and auxiliary adjustment device are separately and independently engageable and disengageable with said lower punches.

37. A method for controlling a rotary press machine to optimize tablet formation, comprising:
rotating at least one pair of upper and lower punches sequentially through a feeding stage in which powder material is fed into a cavity selectively formed in a die by the lower punch, a pressing stage in which the upper and lower punches are pressed together and a tablet ejection stage in which a tablet formed in the die is ejected;
feeding powder material into each die only when the die forms a cavity; and
selectively forming a cavity in the die such that when the cavity is formed, powder material is fed into the die and when the cavity is not formed, powder material cannot be fed into the die, the cavity being formed by engaging an auxiliary device to lower the lower punch ring, and engaging a main device to engage the lower punch ring.

38. The method of claim 37, wherein
the auxiliary device pre-positions the lower punch into a selected position before the main device is engaged and
further comprising the step of disengaging the auxiliary device after the main device is engaged.

39. The method of claim 37, wherein
the step of rotating comprises rotating a plurality of pairs of upper and lower punches.

40. The method of claim 37, wherein
the auxiliary device engages a lower punch ring at a first region and wherein the main device engages the lower punch ring at a second region.

41. The method of claim 37, wherein
the auxiliary device engages a ring on the lower punch.

42. The method of claim 41, wherein the ring is removeable.

43. The method of claim 39, wherein
the plurality of pairs of upper and lower punches are adjacent each other.

44. The method of claim 43, wherein
a plurality of lower punches adjacent each other are provided with rings.
